(19) United States
(12) Patent Application Publication
(10) Pub. No.: US 2005/0195810 A1
(43) Pub. Date: Sep. 8, 2005

(54) Transparent link layer mesh router

(75) Inventors: Danny Te an Sung, Alta Loma, CA (US); Wade D. Mergenthal, Camarillo, CA (US); Simon Wong, Covina, CA (US); Michael A. Johnson, Claremont, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Chang Industry, Inc., La Verne, CA (US)

(21) Appl. No.: 10/793,392

(22) Filed: Mar. 4, 2004

(51) Int. Cl. H04L 12/56

(52) U.S. Cl. 370/389

(57) ABSTRACT

The invention includes network mesh routers and methods for network mesh routing that are capable of transparently routing data packets to other clients on the network. The invention uses the link layer (L2) for route initiation and active client discovery and a combination L2 and the network layer (L3) for passive client discovery. By responding to packets on L2, networks composed of transparent mesh routers require neither configuration by the network operator nor any pre-configuration of the network clients.

### FIELD OF THE INVENTION

The present invention relates to methods, apparatus and systems for communication network data packet routing and more specifically to methods, apparatus and systems for transparent link layer mesh routing in a communication network.

### BACKGROUND OF THE INVENTION

Currently, Local Area Network and Wireless Local Area Network (LAN/WLAN) architecture is composed of network switches, bridges, hubs, routers, wireless access points, and wired and wireless clients. These devices all provide a certain degree of mobility and ease of deployment. Mobility allows the user of a wireless client, such as laptop computer, hand held device or the like to remain actively connected to the network while mobile. It is also possible to impart mobility to other wireless network devices such as switches, bridges, hubs, routers and the like. Ease of deployment is defined by ease of which clients can participate in the network; the less need to reconfigure the client or implement network-related software on the client, the greater the ease of deployment. Additionally ease of deployment is defined in terms of the range of the devices that comprise the network. If wired switches, bridges and routers are implemented, range is typically limited and numerous devices are needed to construct the network. Currently, there is no comprehensive network solution that provides high mobility as well as ease of deployment.

FIG. 1 provides a schematic illustration of a current wired LAN architecture 10, in accordance with the prior art. In this environment, the clients may comprise desktop computer 20, laptop computer 30, hand held computer 40, server 50 or any other suitable client device. The clients are in network communication with hub 60. The hub may comprise a switch, bridge, or the like. In the wired LAN environment, while the clients may be physically detached from one part of the LAN and re-attached elsewhere with minimal interruptions, physical wire constraints limit the distance, accessibility and mobility of wired clients. For example, the Ethernet standard allows for only 100 meters between switches and/or repeaters when untwisted pair wire cables are used. Such a network would benefit from medium/long-haul wireless connections for data transport, allowing the switches or repeaters to be implemented at distances in the miles or kilometer range.

FIG. 2 provides a schematic illustration of the network layer of a LAN 100 implementing routers, in accordance with the prior art. In this environment, two subnets 110 and 120 are defined. Each subnet includes one or more clients, here depicted as desktop computers 20A-20D and routers 130A and 130B. Routers are typically implemented on the network layer and require clients, such as workstations 20, to be configured to be compatible with the network layer. In the case of Internet Protocol (IP), the routers and the clients must be on the same IP subnet. Thus, as shown in FIG. 2, the desktop computers 20A and 20B on subnet 110 must be configured to use router 130A as the gateway in order to communicate with desktop computers 20C and 20D on subnet 120. Conversely, desktop computers 20C and 20D must be configured to use router 130B. By requiring the clients to be configured to use a specific router, the clients may not be mobile unless the network layer specifically allows for such mobility. This lack of mobility means that clients in subnet 110 must be reconfigured when they are moved into router 130B's area of control (i.e., subnet 120).

It is noted that the Internet Engineering Task Force (IETF) currently is addressing a standard for mobility over Internet Protocol version 6 (IPv6). IPv6 is the “next generation” protocol designed to replace the current version Internet Protocol, IP Version 4 (IPv4). The draft standard for mobility may be adopted by IPv4 at some point in the future. However, IPv6 is still in a developmental step and the adoption of a standard for mobility for IPv4 is still speculative.

A need exists to implement a network device below the network layer, on the link layer, that would pass all network layer information through the network. In this regard, the networked clients would be able to access other clients on the network transparently, without any knowledge of the routing device. Such a device would provide more efficiency than the IPv6 mobility because it would not require all of the data packets to be sent to a “home” router prior to being re-sent to another networked client.

A mesh network is a high-level network used to connect widely separated wireless routers that may not “see” each other (e.g., limited to line of sight (LOS)). A network mesh allows any client visible to any router in the mesh to access any other client visible to any other router in the mesh. Currently, most wireless devices, such as wireless routers, wireless bridges, wireless access points and the like do not implement any type of mesh networking. This is because most commercial off-the-shelf (COTS) devices are built to accommodate the current IEEE standard for wireless LAN communication, 802.11. While the 802.11 standard for these devices does not specifically forbid mesh operation, it also does not implicitly allow mesh operation of the wireless devices.

FIG. 3 is a schematic illustration of a wireless LAN 200, in accordance with the prior art. The wireless LAN will comprise wireless access points 210 and wireless bridges (not shown in FIG. 3) that are in wireless communication with workstations 20 or other wireless networked clients. Typically the wireless access points 210 will require a common network backbone 220 (typically a wired network) that all bridges and access points share. The backbone serves as the communication medium that is used to move data packets from one node/router to another networked node/router. In this wireless environment mobility for clients is possible, in that the clients can move from one access point's area of control to another access point's area of control. However, since bridges and access points must be wired together, this limits the ease of deployment of the system and limits the physical size of the network. The need exists to implement routers that can be easily deployed and accommodate large-scale network sizes.

Network layer routers, and specifically network layer mesh routers, typically require client configuration. For example, routers at the network layer may require the client to perform IP address configuration, subnet configuration and/or route table manipulation. Some of these configurations can be accomplished via standard protocols, such as Dynamic Host Configuration Protocol (DHCP). However, the clients need to be configured to use these protocols. Link layer routers differ from network layer routers in that the routers are network protocol independent, thereby allowing the router to communicate with the clients regardless of the communication protocol. However, implementation of link layer routing, and specifically link layer mesh routing, has been hampered by the fact that such use requires a cost-prohibitive custom network stack that would not be supported by existing network architecture.

Thus, a need exists to implement a network that provides high mobility to both clients and routers, extended LAN range without the need to employ additional hardware, and ease of deployment by making client network initiation transparent to the clients joining the network. The need exists to initiate routing on the link layer so that routing can take place independent of network protocol. Such link layer routing should be implemented without having to incorporate a custom network stack; i.e., link layer routing on the existing network architecture is the desired concept.

### BRIEF SUMMARY OF THE INVENTION

The present invention comprises a method and apparatus for transparent mesh routing in a communications network. By implementing transparent mesh routers at the link-layer of the network hierarchy, the routers can be easily deployed in the network without having to reconfigure or add client-side drivers to the networked clients. The present invention uses L2 (Link Layer) for route initiation and active client discovery and a combination L2 and L3 (Network Layer) for passive client discovery. By responding to data packets on Link Layer, networks composed of these transparent mesh routers require neither configuration by the network operator nor any pre-configuration of the network clients. The present invention is able to accomplish link layer route initiation without the need to implement a custom network stack (i.e., the invention utilizes the existing network architecture).

The mesh routers are transparent, in that, they allow clients to access other clients without any knowledge of the routing device being used. The transparent mesh router is capable of dynamically discovering clients and routing data packets to other clients in the network. The transparent mesh router adds efficiency to networked communication because it does not require that all communications be sent to a home node prior to being re-sent to a networked client (as in Mobile IP). In the transparent mesh router environment the networked clients may be mobile or fixed. The transparent mesh router will maintain connectivity between mobile clients with minimal interruption via a self-healing routing algorithm. The transparent mesh router is capable of communicating with other transparent mesh routers via either a wired or wireless backbone. In addition, the transparent mesh router is capable of medium to long-haul wireless connections, allowing for routers to be spaced apart in the range of miles or kilometers.

In one embodiment of the invention a system for network communication is defined that includes one or more clients and one or more transparent mesh routers in network communication with one or more clients. The transparent mesh routers are in network communication via a suitable network backbone. The transparent mesh routers are specified as operating on a data link layer of a network architecture hierarchy.

In the system embodiment the one or more clients may be wireless clients, wired clients or a combination of wireless and wired clients. The network backbone may be a wireless network backbone or a wired backbone. The wireless nature of the clients and the backbone provides mobility to both the clients and the mesh routers as dictated by the requirements of the network.

The one or more transparent mesh routers will typically use the data link layer of the network architecture hierarchy to initiate routes for data packet communication. In addition, the one or more transparent mesh routers will typically use the data link layer of the network architecture hierarchy for active client discovery and a combination of the data link layer and the network layer for passive client discovery.

The one or more clients will typically communicate with the one or more transparent mesh routers via a standard protocol, such as 802.3 Ethernet or the like. The networked backbone will typically implement a standard protocol, such as 802.3 Ethernet or 802.11 wireless LAN, for communication amongst the one or mesh routers. Additionally the network backbone may implement a proprietary datacom as a communication medium between the mesh routers.

In another embodiment, the invention is defined by a transparent mesh routing apparatus for use in a layered communication network. The apparatus includes a client port that receives data packets and a data processing device in communication with the client port, with the data processing device implementing a route initiation routine that utilizes a data link layer of network architecture hierarchy to route the data packets. Additionally, the mesh routing apparatus includes a backbone port in communication with the data processing unit that transmits data packets on the link layer as determined by the route initiation routine.

The route initiation routine utilizes the data link layer of the network architecture hierarchy independent of a network layer of the network architecture hierarchy to route data packets. The apparatus may include a self-healing routine, implemented by the data processing device, that provides continuous data communication between the transparent mesh routing apparatus and one or more mobile clients.

In an alternate embodiment of the apparatus, the mesh routing apparatus is defined by a client port that receives data packets and a data processing device in communication with the client port, with the data processing device implementing a client discovery routine that utilizes a data link layer of network architecture hierarchy to transparently discover networked clients. In addition, the apparatus includes a backbone port in communication with the data processing unit that transmits data packets to networked clients discovered by the client discovery routine.

The client discovery routine utilizes the data link layer of the network architecture hierarchy to discover active clients and utilizes a combination of the link layer and the network layer to discover passive clients. The apparatus may additionally include a self-healing routine, implemented by the data processing device, that provides continuous data communication between the transparent mesh routing apparatus and one or more clients, typically mobile clients.

In yet another embodiment of the invention, a method for data route initiation is defined. The method comprises receiving client data packets at a mesh router. Once the mesh router receives client data packets a route is determined by communicating, on the link layer of the network, route discovery queries from the mesh router to a plurality of networked mesh routers. Once the plurality of networked mesh routers receive the query, they communicate, on the link layer, route discovery responses. A data route is determined upon the mesh router receiving the route discovery responses and determining proper routing based on predetermined priority.

Additionally, the invention is defined as a method for client discovery in a communication network. The method comprises communicating, on a link layer of network architecture hierarchy, client discovery queries from a mesh router. The client discovery requests are received by all networked clients and those clients, which have not been discovered, respond by communicating, on the link layer, client discovery responses. The responses are received by the mesh router, which transparently adds the client to the network without client reconfiguration or the client implementing additional software routines.

As such the present invention provides for a network router and means for network routing that impart a wide-range LAN having high-mobility and ease in deployment. By implementing transparent mesh routers at the link layer of network hierarchy, clients can interface with the network transparently, without having to be configured for the network and without having to implement network-related initiation software. In addition, the clients and the routers may be mobile devices that can function without the risk of service interruption. The use of the mesh routers provides long range routing in the LAN environment that limits the amount of hardware that needs to comprise the overall network.

### BRIEF DESCRIPTION OF THE DRAWINGS

Having thus described the invention in general terms, reference will now be made to the accompanying drawings, which are not necessarily drawn to scale, and wherein:

FIG. 1 is schematic diagram of a wired LAN architecture, in accordance with the prior art.

FIG. 2 is a schematic diagram of a network layer of a wired LAN architecture, in accordance with the prior art.

FIG. 3 is a schematic diagram of a wireless LAN architecture, in accordance with the prior art.

FIG. 4 is a schematic diagram of a wireless LAN architecture implementing mesh routing, in accordance with an embodiment of the present invention.

FIG. 5 is a block diagram of a mesh router, in accordance with an embodiment of the present invention.

FIG. 6 is a flow diagram of a method for mesh routing in a wireless LAN, in accordance with an embodiment of the present invention.

FIG. 7A is a flow diagram of a method for route discovery in a link layer mesh router, in accordance with an embodiment of the present invention.

FIG. 7B is a flow diagram of a method for route query processing at a link layer mesh router, in accordance with an embodiment of the present invention.

FIG. 8 is a block diagram of client communicating with a passive client in a mesh router network, in accordance with an embodiment of the present invention

FIG. 9 is a block diagram of a client communicating with an active client in a mesh router network, in accordance with an embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention comprises methods, apparatus and systems for transparent mesh routing in a communications network. The routers are transparent, in that, they allow clients to access other clients without any knowledge of the routing device being used and without the need to reconfigure the accessing clients. The transparent aspect of the mesh router is realized by its ability to dynamically discover clients and route data packets to other clients in the network.

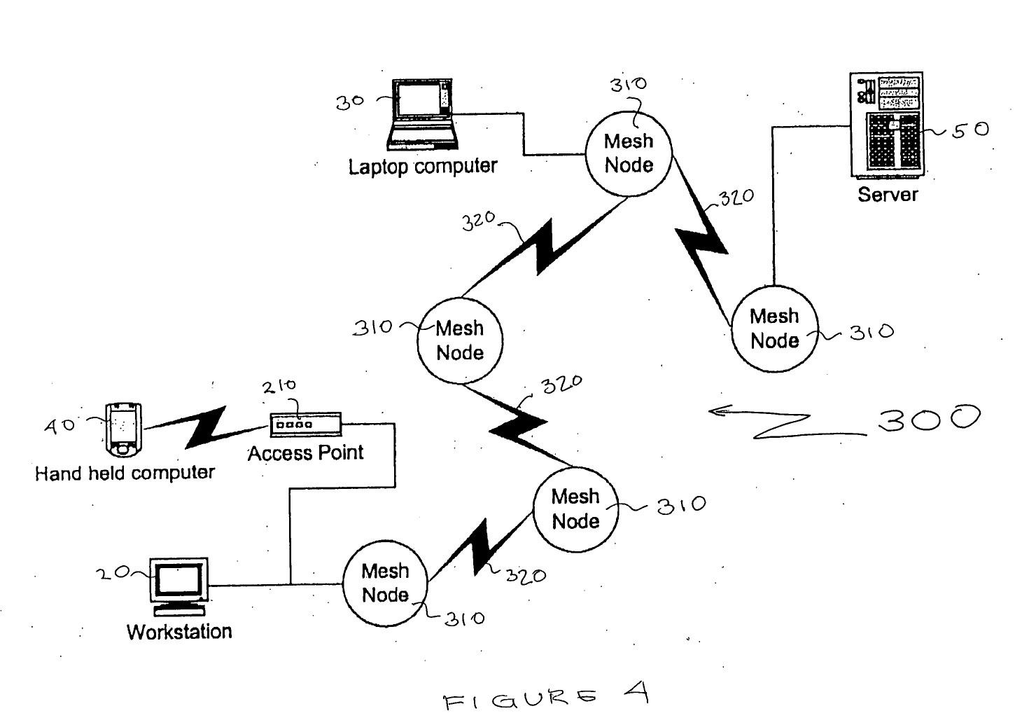

FIG. 4 is a schematic illustration of a communication system implementing a transparent mesh router, in accordance with an embodiment of the present invention. The communication network 300 is a wireless Local Area Network (LAN) that implements transparent mesh routers 310 to provide a communication link to network connected clients. The transparent mesh routers will operate on the link layer of the network hierarchy allowing for ease of operation for end users. Operation of the mesh routers on the link layer is independent of network protocol. For example, the link layer communications may include Internet Protocol (IP), AppleTalk, IPX or the like.

The mesh routers 310 are in communication with one or more clients, such as workstation 20, laptop computer 30, hand held computer 40, server 50 or any other suitable client device. The mesh routers may also be in communication with bridges or access points 210 that provide a wireless connection point for clients, such as hand held computer 40. Clients may be fixed, such as the workstation 20, laptop computer 30 and server 50 shown in FIG. 4 or they may be mobile such as the hand held computer 40 shown in FIG. 4. Additionally, the network includes a network backbone 320 that serves as the communication medium for the transparent mesh routers. The communication network system of the present invention may utilize any suitable wireless communication medium as the backbone, such as IEEE standard 802.3, IEEE standard 802.11 wireless LAN, proprietary datacom or the like. Additionally, it is possible for transparent mesh routers to implement a wired backbone. In the wireless backbone environment, as depicted in FIG. 4, the transparent mesh routers may also be capable of being mobile.

The transparent mesh routers operate on the link layer of the network architecture hierarchy. The transparent mesh routers use the link layer for route initiation and active client discovery. Active clients are defined as those clients that initiate network traffic. Active client discovery involves initiating a query to confirm existence of the active client. It should be noted that if the link layer of the network does not support active queries, the present invention will rely on mechanisms in the network layer, for example 802.3 Ethernet does not have the ability to query for clients, while Internet Protocol (IP) contains a query specification.

In addition to querying the active clients on the link layer, the transparent mesh routers use a combination of the link layer and the network layer of the network architecture hierarchy for passive client discovery. Passive clients are defined as those clients that do not initiate network traffic, but will respond to network traffic if queried. Passive client discovery involves examining the source of the packets to infer existence of a client.

Any network configuration that works in a typical LAN environment will also work correctly if the transparent mesh routers are used in place of or in conjunction with the standard LAN infrastructure of network hubs, switches or the like. Thus, the mesh routers can be added to existing LAN infrastructure or substituted in place of existing routers without affecting the overall network functionality. In addition, clients that are within the network structure do not require reconfiguration or any additional knowledge or drivers to make use of the transparent mesh routers. Thus, the transparent mesh routers can easily be deployed in existing LAN architecture and clients can be added to the network without having to undergo reconfiguration or additional driver/software modification.

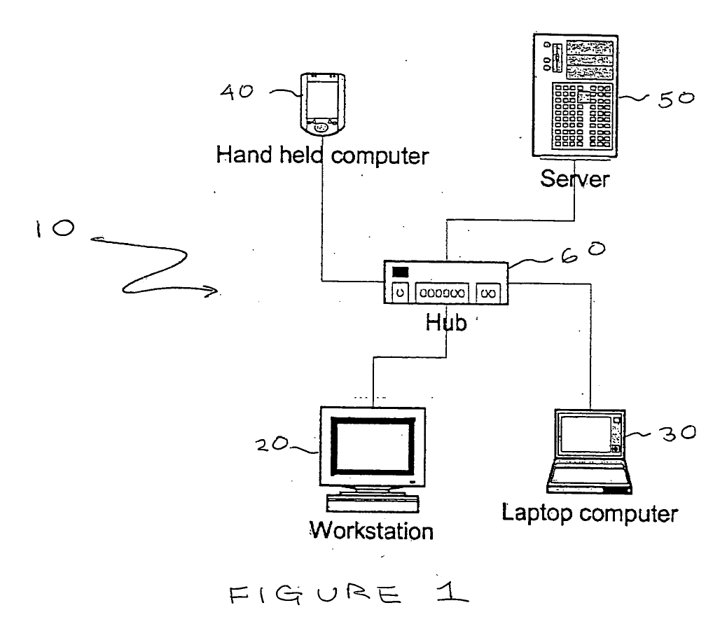

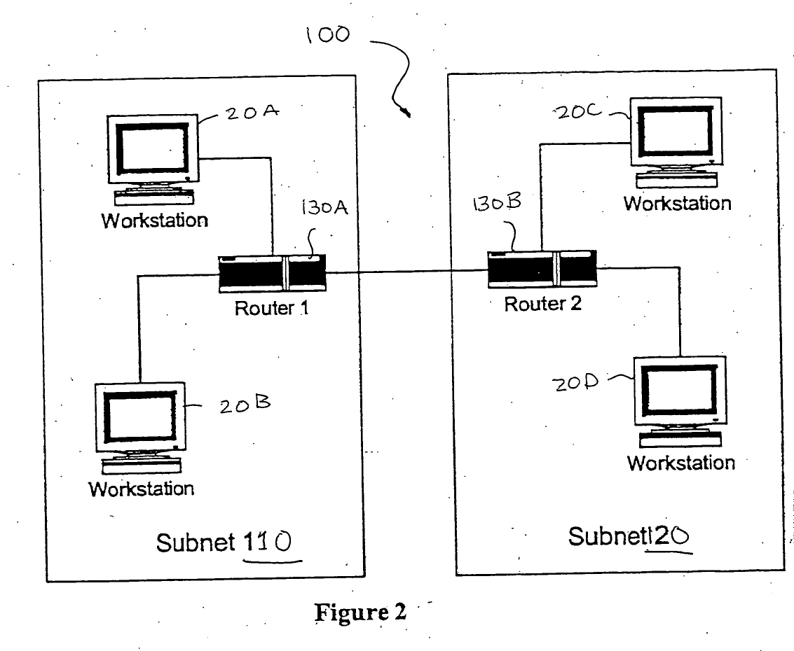

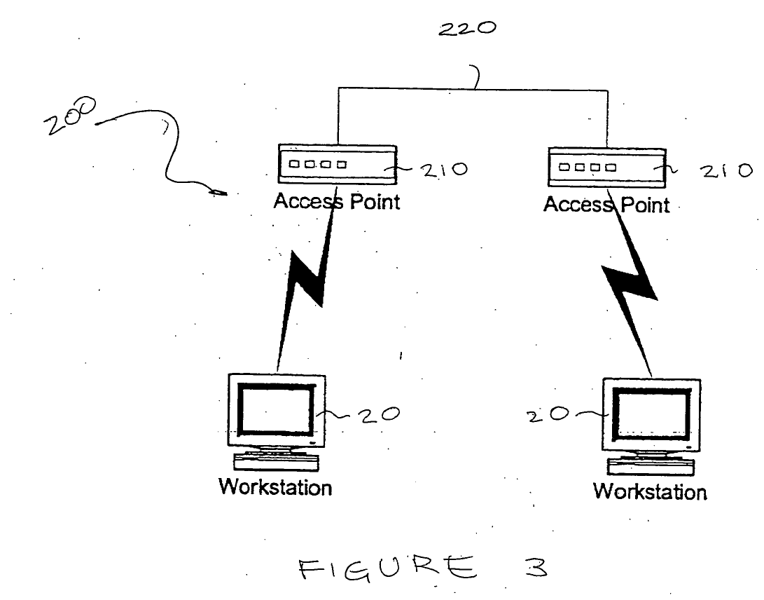

The transparent nature of the mesh router allows for the network client to view the mesh router as equivalent to that of a standard LAN network connected by switches/hubs, as shown in FIG. 1. However, as opposed to the wired LAN environment in which the routers are spaced apart in terms of meters, in the wireless LAN implementing transparent mesh-routers the mesh router-to-mesh router link may be spaced apart in terms of miles or kilometers. Further, extending the range of the network may be accomplished by placing additional transparent mesh routers in-between existing mesh router-to-mesh router links.

FIG. 5 is a block diagram of a transparent mesh router, in accordance with an embodiment of the present. The transparent mesh router will typically make use of conventional Ethernet based LAN IEEE standard 802.3, thus, the hardware that comprises the mesh routers may include standard COTS products, such as Ethernet cards, wireless network cards and the like. As such, no custom hardware is required to be implement or operate the transparent mesh routers of the present invention.

The transparent mesh router 310 of the present invention will include a data processing device 400 that provides data processing capabilities for the mesh router. The data processing device processes data packets that are communicated from networked clients or from networked mesh routers. The data packets are received by the transparent mesh router via client input/output port 410. Once the data processing device of the transparent mesh router determines the route of the data packets, the data packets are communicated to the “next” mesh router or to the destination client. The data packets are communicated by the transparent mesh router at router backbone input/output port 420.

In one embodiment of the invention the data processing unit will implement a route initiation routine 430. The route initiation routine provides for data packet routing on the link layer of the network architecture hierarchy. The route initiation routine may be based on a variation of the Ad-hoc On-demand Distance Vector (AODV) network standard or any other suitable mesh/ad-hoc network routine may be used. The memory device 440 is in communication with data processing device and provides the data processing device with a list of known destination addresses, which are used in the route initiation process. The memory device may exist within the mesh router, as shown in FIG. 5, or the memory device may be incorporated in an associated device or as a stand-alone unit. In another embodiment of the invention the data processing unit will implement a client discovery routine 450. The client discovery routine will discover active clients on the link layer and passive clients will be discovered using a combination of the link layer and the network layer of the network architecture hierarchy.

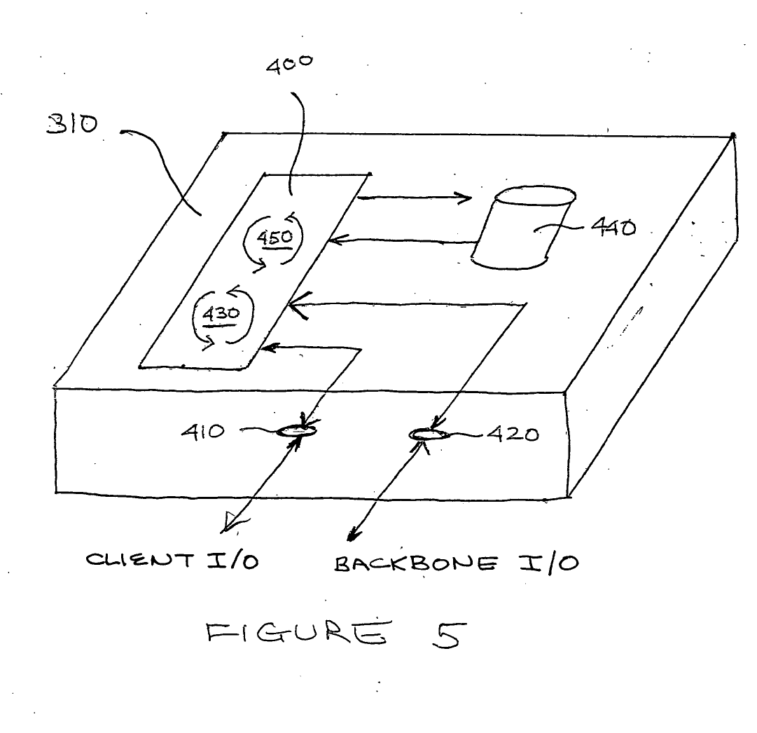

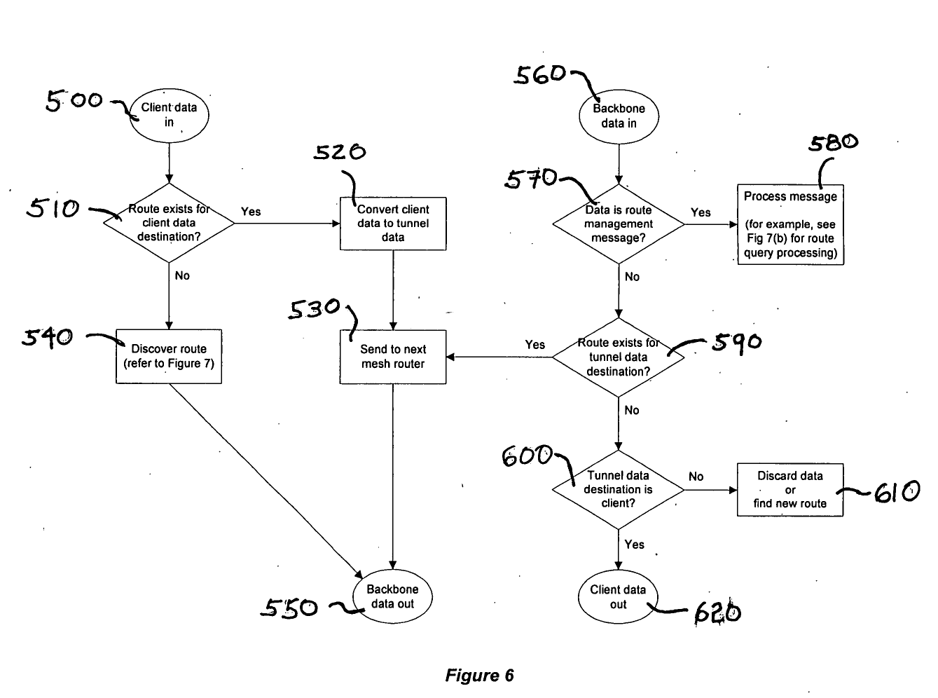

FIG. 6 provides a flow diagram of a method for data packet routing in a transparent mesh router, in accordance with an embodiment of the present invention. At step 500, the mesh router receives data packets from a networked client. At step 510, the mesh router determines whether a route exists for the client data destination (i.e., whether the packets are presently routable). Client data is defined as data being transmitted to or from a client on the client input/output port. This determination is made by reading the destination MAC (Medium Access Control) address in the data packet header. The MAC address is a hard-coded interface identification used by layer 2 devices for proper forwarding of data packets between computers on a network. Once the destination MAC address is determined, the mesh router determines whether this address is a routable address. This determination is made by accessing a stored list of destination addresses, typically maintained in mesh router RAM memory. Each stored destination address will have a mesh router associated with the address. The associated mesh router is the next router in the routing scheme for the destination address. If the address is determined to be routable then, at step 520, the client data is converted to tunnel data and at step 530, the data packets are routed through the network backbone to the next mesh router in the communication system. The next mesh router will determine if the data packets are destined for one of its clients, if so, the data packets are delivered to the client. Otherwise, the next mesh router, at step 550, reformats the data packets and sends the data packets on to the network backbone for further communication to the next router in the routing scheme.

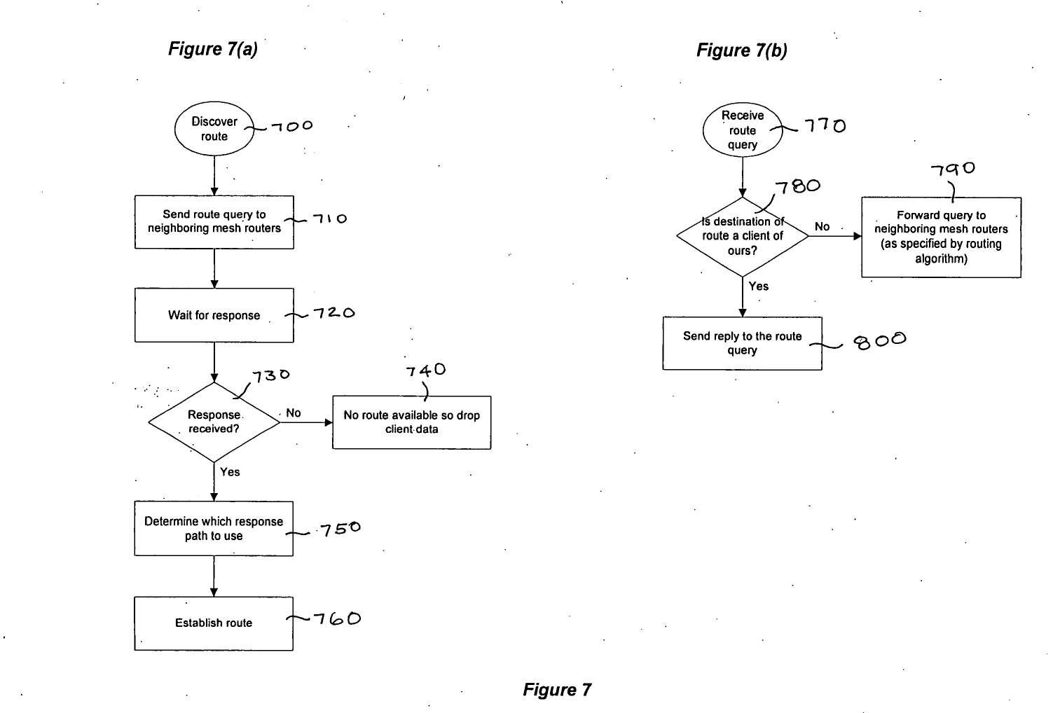

If the mesh router determines that the destination MAC address of the data packet is not routable (i.e., the destination MAC address is not currently maintained in the associated memory) then, at step 540, a route discovery process is undertaken. Route discovery is accomplished by sending out a query from the mesh router to all other networked mesh routers to determine which mesh router should be forwarded the data packets next. The mesh routers that receive the query determine if the destination address of the data packets is currently maintained in associated RAM. Mesh routers that currently maintain the destination address respond to the querying mesh router and the querying mesh router then determines which networked mesh router should be forwarded the data packets next. The route discovery routine may define which mesh router is next according to a predefined parameter. These parameters may include, but are not limited to, the first response by a router to the query, the route discovery response with the best Received Signal Strength Indicator (RSSI), the response that traverses mesh routers with the best battery life or any combination of these parameters. Upon determination of the next mesh router, the destination address and corresponding next mesh router are stored in list of routable destination addresses. For a more detailed description of the route discovery process see the flow diagram of FIG. 7 and related discussion. Once a route is determined, the data packets are reformatted and communicated, at step 550, on the network backbone to the next mesh router indicated in the discovered route.

At step 560 the “next” mesh router in the routing scheme receives data packets from a networked mesh router (as opposed to from a network client). At step 570, a determination is made as to whether the data in the packets is a route management message. Route data is defined as control data for the transparent mesh routers and exists only on the backbone input/output port. By way of example, a route management message may provide assistance in maintaining network routes for data packet transmission through the network. If it is determined that the data is a route management message then, at step 580, the message is processed (for a more detailed discussion of the message processing see FIG. 7B and the related discussion). If it is determined that the data is not a route management message then, at step 590, the mesh router determines if a route exists for the tunnel data destination (i.e., whether the data packets are presently routable. This determination is made by reading the destination MAC and determining whether this address is stored in associated mesh router RAM memory. If the address is stored in memory it will be associated with a “next” mesh router and this router is the next router in the routing scheme for the destination address. If the address is determined to be routable then, at step 530, the data packets are routed through the network backbone to the next mesh router in the communication system. The next mesh router determines if the data packets are destined for one of its clients, if so, the data packets are delivered. Otherwise, at step 550, the data packets are reformatted and communicated to the network backbone and are subsequently sent to the next mesh router.

If the mesh router determines that the no route exists for the tunnel data destination (i.e., the destination MAC address is not currently maintained in the associated memory) then, at step 600, a determination is made as to whether the tunnel data destination is a client. Tunnel data is defined as client data that has been reformatted to be transmitted on the backbone input/output port through an established (i.e., discovered) route. If the tunnel data destination is determined not to be a client then, at step 610, the data packets are dropped and no further processing occurs or a new route for the packets is determined. If the tunnel data destination data is a client then, at step 620, the data is communicated to the client.

FIG. 7 provides a flow diagram of the method for route discovery at mesh router, in accordance with an embodiment of the present invention. In the depicted flow, route discovery begins at step 700, once the router has determined that no route exists for the client data. It should be noted that step 700 is equivalent to step 540 of FIG. 6. At step 710, the mesh router will commence route discovery by sending a route query to neighboring mesh routers. At step 720, the mesh router will wait for a predetermined time period for responses to the route query and at step 730, a determination is made as to whether a response has been received. If no response is received within the predetermined time period, at step 740, the mesh router assumes that no route is available and the router drops the client data from further processing. If a response is received then, at step 750, the mesh router determines which response path to use as the assigned route. As previously noted the assigned route may be based on query response time, the response with the best Received Signal Strength Indication (RSSI), the response that traverses routers with the best battery life, a combination of these attributes or any other significant routing attribute. Once the determination is made as the route that will be used, at step 760, the route is established and is stored in router associated memory, so that subsequent data packets with like destination MAC addresses will be routed according to the established route.

FIG. 7B provides a flow diagram of a method for route query processing at a link layer mesh router, in accordance with an embodiment of the present invention. In the depicted flow, route query begins at step 770, once the router has received the route query. It should be noted that the flow of FIG. 7B is an example of a route management message and the processing of such, as shown in FIG. 6 step 580. At step 780, the mesh router determines whether the destination address of the route is a client of the mesh router. This step is performed by accessing storage associated with the router to determine if the destination address is listed as a client. If the destination address of the route is not a client then, at step 790, the route query is forwarded to neighboring mesh routers to determine mesh router that has a client associated with the destination of the route. The neighboring mesh routers will typically be specified in the route discovery routine. If the destination address of the route is a client then, at step 800, the mesh router will respond to the route query with a corresponding reply.

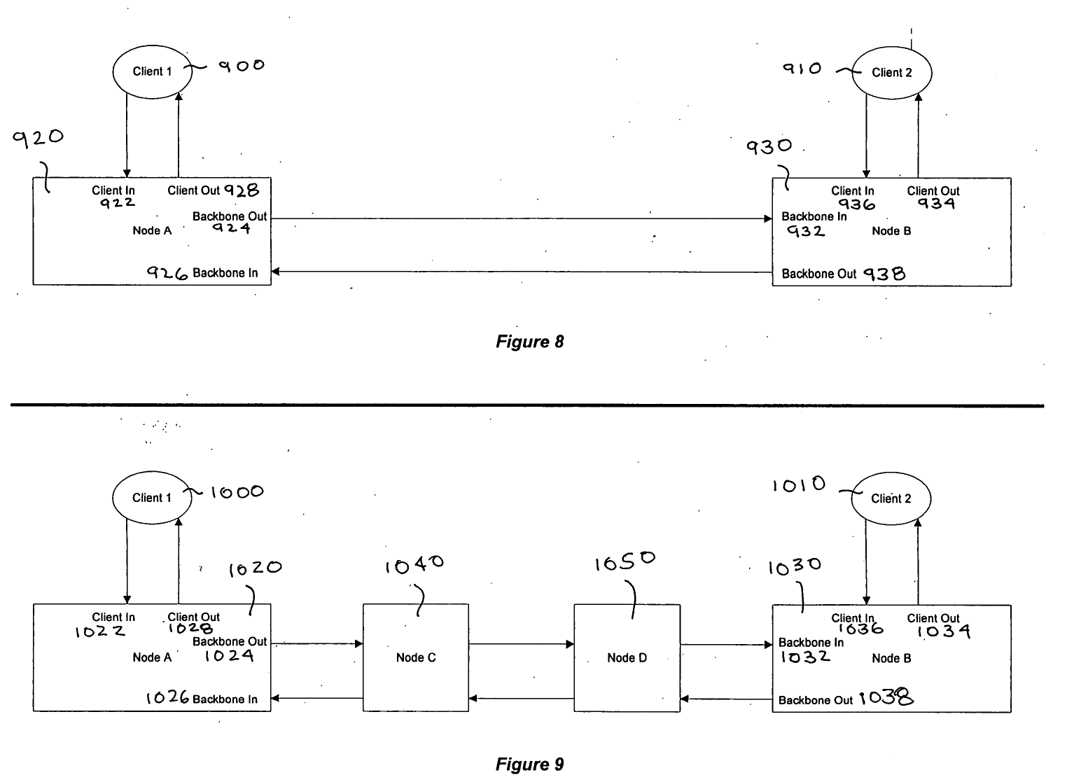

FIG. 8 provides a block diagram of client communicating with a passive client in a mesh router network, in accordance with an embodiment of the present invention. The first client 900 attempts to communicate with second client 910, a passive client, by sending a data transmission. The data transmission is received by first mesh router 920 on the client input port 922. The first mesh router will examine the destination address of the data transmission to determine if a route exists. If a route exists the mesh router will convert the client data to tunnel data. If no route exists the mesh router must discover the route (see FIG. 7A and related discussion) prior to converting the client data to tunnel data. Once the route has been determined or established and the data has been converted the data is sent to the next mesh router in the route via backbone outlet port 924.

The second mesh router 930 will receive the tunnel data via backbone input port 932. It is noted that the tunnel data may pass through one or more intermediary mesh routers (not shown in FIG. 8) prior to receipt at the second mesh router. Since the second client is a passive client, the second mesh router is unaware of the second client's presence. The second mesh router initiates active client discovery and the second client responds to the second mesh router's query. Upon receipt of the client response by the second mesh router, the second mesh router converts the tunnel data to client data and sends the data to the second client via client output port 934.

Data transmission from the second client to the first client may occur in likewise fashion, assuming that the first client is a passive client. Data transmission from the second client is received at the second mesh router via client input port 936, a route is identified, the client data is converted to tunnel data and communicated to the backbone via backbone output port 938. The first mesh router receives the tunnel data via backbone input port 926, followed by client discovery and conversion of the tunnel data to client data. The data is then transmitted to the first client via client output port 928.

FIG. 9 provides for a block diagram of a client communicating with an active client in a mesh router network, in accordance with an embodiment of the present invention. The first client 1000 attempts to communicate with second client 1010, an active client, by sending a data transmission. The data transmission is received by first mesh router 1020 on the client input port 1022. The first mesh router will examine the destination address of the data transmission to determine if a route exists. If a route exists the mesh router will convert the client data to tunnel data. If no route exists the mesh router must discover the route (see FIG. 7A and related discussion) prior to converting the client data to tunnel data. Once the route has been determined or established and the data has been converted the data is sent to the next mesh router in the route via backbone outlet port 924.

The second mesh router 1030 will receive the tunnel data via backbone input port 1032. As depicted, the tunnel data has passed through intermediary mesh routers 1040 and 1050 prior to receipt at the second mesh router. Since the second client is an active client, the second mesh router has already passively discovered the second client. Thus, upon receipt of the tunnel data, the second mesh router converts the tunnel data to client data and sends the data to the second client via client output port 1034.

Data transmission from the second client to the first client may occur in likewise fashion, assuming that the first client is an active client. Data transmission from the second client is received at the second mesh router via client input port 1036, a route is identified, the client data is converted to tunnel data and communicated to the backbone via backbone output port 1038. The first mesh router receives the tunnel data via backbone input port 1026, followed by conversion of the tunnel data to client data. The client data is then transmitted to the first client via client output port 1028.

As such the present invention provides for a network router and means for network routing that impart a wide-range LAN having high-mobility and ease in deployment. By implementing transparent mesh routers at the link layer of network hierarchy, clients can interface with the network transparently, without having to be configured for the network and without having to implement network-related initiation software. In addition, the clients, as well as, the routers may be mobile devices that can function without the risk of service interruption. The use of the mesh routers provides long range routing in the LAN environment that limits the amount of hardware that needs to comprise the overall network.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for network communication, the system comprising:
one or more clients;
one or more transparent mesh routers in network communication with one or more clients, wherein the transparent mesh routers operate on a data link layer of a network architecture hierarchy; and
a network backbone in network communication with the one or more transparent mesh routers that serves as the communication medium for mesh router-to-mesh router data communication.

2. The system of claim 1, wherein the one or more clients further comprise one or more wireless network devices.

3. The system of claim 1, wherein the one or more clients further comprise one or more wired network devices.

4. The system of claim 1, wherein the one or more clients further comprise one or more wireless network devices and one or more wired network devices.

5. The system of claim 1, wherein the one or more transparent mesh routers use the data link layer of the network architecture hierarchy to initiate routes for data packet communication.

6. The system of claim 1, wherein the one or more transparent mesh routers use the data link layer of the network architecture hierarchy for passive client discovery.

7. The system of claim 1, wherein the one or more transparent mesh routers use a network link layer of the network architecture hierarchy for active client discovery.

8. The system of claim 1, wherein the one or more clients communicate with the one or more transparent mesh routers via standard 802.3 Ethernet protocol.

9. The system of claim 1, wherein the network backbone communicates with the one or more transparent mesh routers via a communication protocol chosen from the group consisting of 802.3 Ethernet, 802.11 wireless LAN or proprietary datacom.

10. The system of claim 1 wherein the network backbone is further defined as a wireless network backbone.

11. The system of claim 1, wherein the network backbone is further defined as a wired network backbone.

12. The system of claim 1, wherein the one or more transparent mesh routers are implemented in modular fashion.

13. A transparent mesh routing apparatus for use in a layered communication network, the apparatus comprising:
a client port that receives data packets
a data processing device in communication with the client port, the data processing device implementing a route initiation routine that utilizes a data link layer of network architecture hierarchy to route the data packets; and
a backbone port in communication with the data processing unit that transmits data packets on the link layer as determined by the route initiation routine.

14. The apparatus of claim 13, wherein the route initiation routine utilizes the data link layer of network architecture hierarchy independent of a network layer of the network architecture hierarchy to route data packets.

15. The apparatus of claim 13, further comprising a client discovery routine implemented by the data processing device, the client discovery routine utilizes the data link layer of the network architecture hierarchy to discover active clients.

16. The apparatus of claim 15, wherein the client discovery routine utilizes a network layer and the data link layer of the network architecture hierarchy to discover passive clients.

17. The apparatus of claim 15, wherein the client discovery routine is able to discover clients transparently.

18. The apparatus of claim 13, further comprising a self-healing routine that provides continuous data communication between the transparent mesh routing apparatus and one or more mobile clients.

19. A transparent mesh routing apparatus for use in a layered communication network, the apparatus comprising:
a client port that receives data packets
a data processing device in communication with the client port, the data processing device implementing a client discovery routine that utilizes a data link layer of network architecture hierarchy to transparently discovery networked clients; and
a backbone port in communication with the data processing unit that transmits data packets to networked clients discovered by the client discovery routine.

20. The apparatus of claim 19, wherein the client discovery routine that utilizes the data link layer of the network architecture hierarchy to discover active clients.

21. The apparatus of claim 19, wherein the client discovery routine utilizes a network layer and the data link layer of the network architecture hierarchy to discover passive clients.

22. The apparatus of claim 19, further comprising a route initiation routine implemented by the data processing unit, the route initiation routine utilizes the data link layer of network architecture hierarchy to route the data packets.

23. The apparatus of claim 19, further comprising a self-healing routine that provides continuous data communication between the transparent mesh routing apparatus and one or more mobile clients.

24. A method for data route initiation on a communication network, the method comprising:
receiving client data packets at a mesh router;
communicating, on a link layer of network architecture hierarchy, route discovery queries from the mesh router to a plurality of networked mesh routers;
communicating, on the link layer, route discovery responses from one or more of the plurality of networked mesh routers to the mesh router; and
determining the data route at the mesh router based upon the route discovery responses.

25. A method for client discovery on a communication network, the method comprising:
communicating, on a link layer of network architecture hierarchy, client discovery queries from a mesh router;
communicating, on the link layer, client discovery responses from one or more networked clients to the mesh router; and
networking the discovered clients in response to the mesh router receiving the client discovery responses,
wherein the client is transparently discovered independent of configuration of the discovered client.
